(19) United States
(12) Patent Application Publication
(10) Pub. No.: US 2024/0121629 A1
(43) Pub. Date: Apr. 11, 2024

(54) UNSUPERVISED MACHINE LEARNING TO DERIVE OPTIMAL WIRELESS CONNECTIVITY THRESHOLDS FOR BEST NETWORK PERFORMANCE

(71) Applicant: Fortinet, Inc., Sunnyvale, CA (US)

(72) Inventors: Vedaang Chopra, Ulsoor, Bangalore (IN); Deepti Girish, Kasturinagar, Bangalore (IN); Siva Rama Krishna Rao Yogendra Jupudi, Bangalore (IN)

(21) Appl. No.: 17/958,026

(22) Filed: Sep. 30, 2022

(51) Int. Cl. H04W 24/02; G06N 5/022; H04W 24/08; H04W 76/11

(52) U.S. Cl. CPC H04W 24/02; G06N 5/022; H04W 24/08; H04W 76/11

(57) ABSTRACT

Dynamic thresholds are derived for each connection phase, using machine learning (e.g., K-means clustering) for an enterprise network. A time interval can be tracked between samples of collected data packets for each phase of connections, including the association phase, the authentication phase and the DHCP phase of connecting. A specific dynamic threshold for one of the connection phases is detected as out-of-range. Responsive to the out-of-range detection, network issues corresponding to the phase of the specific dynamic threshold are checked and automatically remediated.

### FIELD OF THE INVENTION

The invention relates generally to machine learning and computer networking, and more specifically, for using unsupervised machine learning to derive thresholds for each connection phase, unique for an enterprise network, as a baseline for identifying issues for new connections at different phases.

### BACKGROUND

A handshaking process occurs between devices on a wireless networking for connecting, for example, a wireless station to an access point. The handshaking involves three phases, an association phase, an authentication phase, and a DHCP phase.

In more detail, the association phase exchanges packet probes for an association request and an association response. Next, the authentication phase exchanges packet probes for handshake-M1, handshake-M2, handshake-M3 and handshake-M4 (i.e., 4-way handshake) to generate encryption keys used to encrypt data. Finally, the DHCP phase of packet probes perform dynamic host configuration protocol (DHCP) Discover, DHCP-Offer, DHCP-Request and DHCP-ACK). The time taken to connect is a cumulative sum of all packet exchanges.

Problematically, each wireless network is unique. The time taken to connect provides little insight to problems arising during specific aspects of connecting.

What is needed is a robust technique for using unsupervised machine learning to derive thresholds for each connection phase, unique for an enterprise network, as a baseline for identifying issues for new connections at different phases.

### SUMMARY

To meet the above-described needs, methods, computer program products, and systems for using unsupervised machine learning to derive thresholds for each connection phase, unique for an enterprise network, as a baseline for identifying issues for new connections at different phases.

In one embodiment, a service set identifier (SSID) is monitored, with an exchange of data packets over the enterprise network between network devices, to collect real-time network device connections statistics associated with the SSID as a whole and each station utilizing the SSID. A time interval can be tracked between samples of collected data packets for each phase of connections, including the association phase, the authentication phase and the DHCP phase of connecting.

In another embodiment, cluster means are identified for the tracked time differences for each of the connection phases. Next, weighted averages are calculated for each connection phase using the time difference, the cluster means and the number of samples in each cluster. Finally, dynamic thresholds are derived for each connection phase from the weighted averages.

In yet another embodiment, a specific dynamic threshold for one of the connection phases is detected as out-of-range. Responsive to the out-of-range detection, network issues corresponding to the phase of the specific dynamic threshold are checked and, in some cases, automatically remediated.

Advantageously, network performance is improved with better diagnosis of network connectivity issues. In turn, network devices will operate better with better network connectivity.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for using unsupervised machine learning to derive thresholds for each connection phase, unique for an enterprise network, as a baseline for identifying issues for new connections at different phases, according to one embodiment.

FIG. 2 is a more detailed block diagram illustrating a connection manager of the system of FIG. 1, according to one embodiment.

FIG. 3 is a chart illustrating multiple cluster samples with thresholds, according to one embodiment.

FIG. 4 is a high-level flow diagram illustrating a method for identifying network issues from connectivity data, according to one embodiment.

FIG. 5 is a more detailed flow diagram illustrating a step for using unsupervised machine learning to derive thresholds for each connection phase, unique for an enterprise network, as a baseline for identifying issues for new connections at different phases, from the method of FIG. 4, according to one embodiment.

FIG. 6 is a block diagram illustrating an exemplary computing device for the system of FIG. 1, according to one embodiment.

### DETAILED DESCRIPTION

Methods, computer program products, and systems for using unsupervised machine learning to derive thresholds for each connection phase, unique for an enterprise network, as a baseline for identifying issues for new connections at different phases. One of ordinary skill in the art will recognize many alternative embodiments that are not explicitly listed based on the following disclosure.

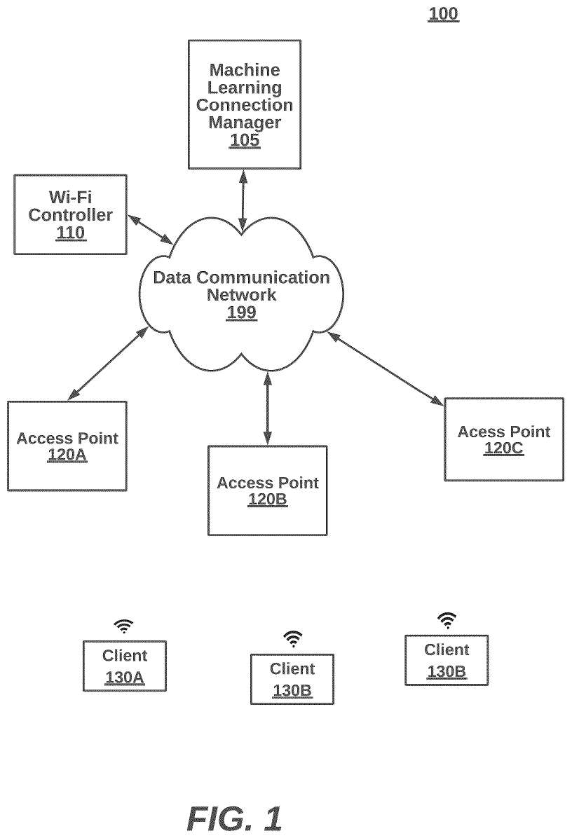

I. Systems for Deriving Connection Thresholds (FIGS. 1-3)

FIG. 1 is a high-level block diagram illustrating a system 100 for using unsupervised machine learning to derive thresholds for each connection phase, unique for an enterprise network, as a baseline for identifying issues for new connections at different phases, according to one embodiment. The system 100 includes a machine learning connection manager 105, a Wi-Fi controller 110, a group of access point 120A-C, and clients 130A-C, coupled in communication with a data communication network 199. Other embodiments of the system 100 can include additional network components that are not shown in FIG. 1. For example, there can be more access points (authorized and unauthorized) and more stations. There can also be network devices such as switches, routers, fire walls, proxy servers, network gateways, network managers, and the like. Many other variations are possible.

The components of the system 100 are coupled in communication over the data communication network. The components can be connected to the data communication system via hard wire (e.g., machine learning connection manager 105, the Wi-Fi controller 110 and the group of access points 120A-C). The components can also be connected via wireless networking (e.g., the clients 130A-C). The data communication network 199 can be composed of any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, and the like. Components can use IPv4 or IPv6 address spaces.

The machine learning connection manager 105 derives dynamic thresholds for each connection phase, using unsupervised machine learning. Generally, unsupervised machine learning analyzes and clusters unlabeled datasets. Baselines can be determined by K-means clustering or other statistical modeling, and derivations from the baselines can be detected as an indicator of network issues. One embodiment derives an association threshold, an authentication threshold and a DHCP threshold. Other baselines can be derived for roaming or SDWAN. The baselines can be a time period for the phase during a connection of any network device (e.g., station to access point, access point to Wi-Fi controller, network gateway to network manager, and the like). Another embodiment automatically diagnoses and corrects the network connectivity issue. There are many different potential causes, such as, without limitation, high access point density, Wi-Fi interference, high client density, slow cryptographic algorithms, poor uplinks, and high channel utilization.

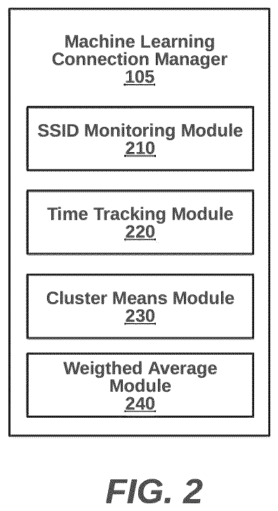

The machine learning connection manager 105 can be an independent network device, integrated within the Wi-Fi controller 110, integrated within the access points 120A-C, gateways, or other network devices. Additional embodiments of the machine learning connection manager 105 are set forth below in association with FIG. 2.

The group of access points 120A-C are composed of individual access points managed by the Wi-Fi controller 110. An access point can have downstream connections with stations and upstream connections with Wi-Fi controllers and other network devices. For stations, beacons are broadcast to advertise presence of SSIDs for connection. The three connection phases are completed to connect a station with the access point. Once connected, data packets can be exchanged across an enterprise network, or over the Internet.

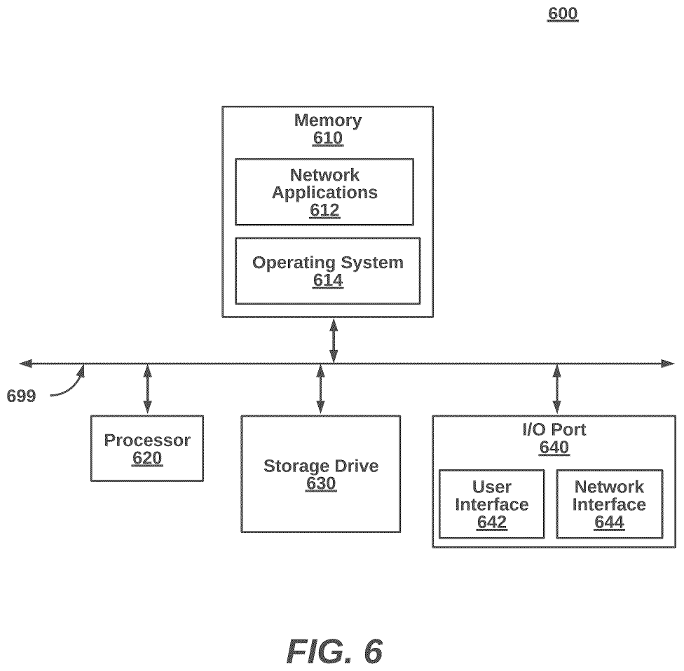

The access points 120A-C can be any of the computing devices, such as a personal computer, a server blade, any computing environment as shown in FIG. 6. The access points 120, 130 are preferably connected to the network (or to a switch, router, hub, or another access point that is connected to the network 199) via a wired or wireless connection. The access points 120A-C can be set-up in various configurations with other access points to provide wireless coverage areas. In one embodiment, the functionality is incorporated into a switch or router, and in another embodiment, is incorporated into a custom enclosure. In operation, the access points 120A-C transmit network packets to and from stations.

The clients 130A-C use access points 120A-C to for access to the wired backbone and to other devices on a Wi-Fi network. When mobile, the clients 130A-C can connect with access point 120A and then later connect with access point 120B while roaming across an enterprise network, without interruption of services. Full connections may not be performed for such handoffs. One embodiment calculates distinct thresholds for handoffs relative to brand new connections or return connections to the enterprise network. The clients 130A-C can be implemented as, for example, a mobile station, STA, client or wireless device, a personal computer, laptop, tablet computer, smart phone, mobile computing device, Internet access applications, end station or any other computing device as described in FIG. 6. The clients 130A-C are wirelessly couples to access points using a radio and antenna. No pre-configuration or client is needed. The clients 130A-C can operate according to wireless standards such as IEEE 802.11a, b, g, n, ac, w or any other wireless standard.

FIG. 2 is a more detailed block diagram illustrating the machine learning connection manager 105 of the system of FIG. 1, according to one embodiment. The machine learning connection manager 105 includes an SSID monitoring module 210, a time tracking module 220, a cluster means module 230, and a weighted average module 240. The components can be implemented in hardware, software, or a combination of both.

The SSID monitoring module 210 tracks one or more SSIDs, while exchanging data packets over the enterprise network between network devices, to collect real-time network device connections statistics associated with the SSID as a whole and each station utilizing the SSID.

The time tracking module 220 monitors a time interval between samples of collected data packets for each phase of connections, including the association phase, the authentication phase and the DHCP phase of connecting.

The cluster means module 230 can identify cluster means for the tracked time differences for each of the connection phases. Generally, K-means computes centroids and repeats until an optimal centroid is found. Euclidean distance between data points helps identify similarity. Another option, mini batch K-means uses mini-batches to reduce computation time within tolerable accuracy drops because convergence is faster. Other possible clustering techniques include Gaussian mixture models, K-medoids, density-based spatial clustering of applications with noise (DBSCAN). One embodiment uses multiple models such as Gaussian mixture models and K-means. Many other variations are possible, including non-clustering techniques.

The weighted average module 240 calculates, in an embodiment, weighted averages for each connection phase using the time difference, the cluster means and the number of samples in each cluster. The metric weighted average is the threshold in some implementations.

$$Weighted - Average = {\sum }_{i} sum ( {a}_{i} * {weights}_{i} ) / sum ( weights ) , where a = Time Difference taken by Sample I , and weights = Calculated weight for each sample \qquad ( 1 )$$

$$Weighted - Average = {\sum }_{i} ( Time {Difference}_{i} * Calculated / Assigned Weight ) / Sum of all Weights \qquad ( 2 )$$

$$Assigned Weight = \frac{\begin{matrix}Number of Samples in the {cluster}_{i} in \\ which Time {Difference}_{i} belongs\end{matrix}}{\begin{matrix}Mean / Center of Clusteri in \\ which the Time Differencei belongs\end{matrix}} \qquad ( 3 )$$

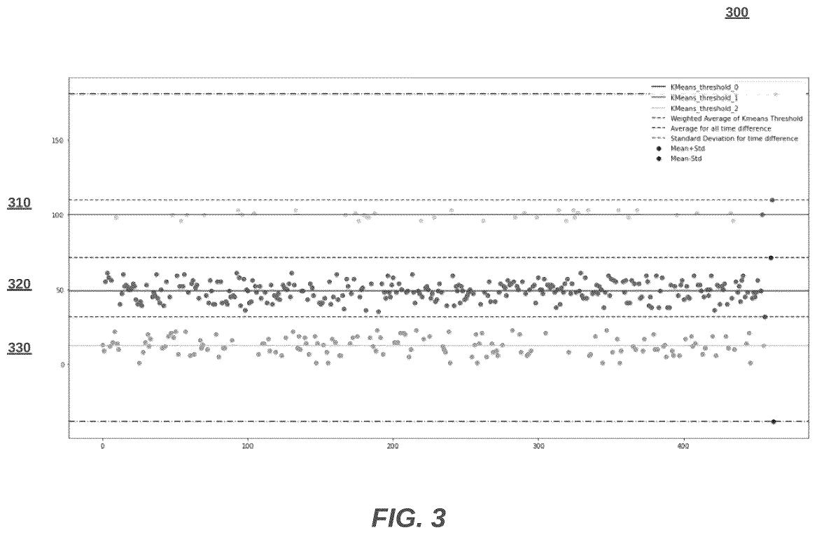

The optimal threshold module 250 derives dynamic thresholds for each connection phase from the weighted averages. An alert or notification can be sent when a specific dynamic threshold for one of the connection phases that is out of range. In FIG. 3, a chart of each of the three thresholds are shown in relation to underlying data samples.

The network correction module 260, responsive to the out-of-range detection, checks for network issues corresponding to the phase of the specific dynamic threshold. For example, AIOps alerts a network administrator when time spent by the clients in any of the phases. In one embodiment, connectivity issues are automatically identified and addressed. Machine learning can again be deployed for solving connectivity problems unique to an enterprise network.

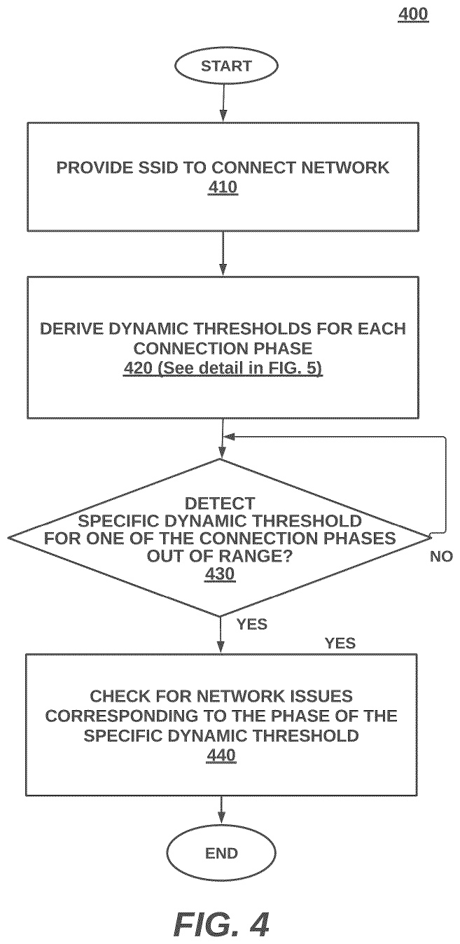

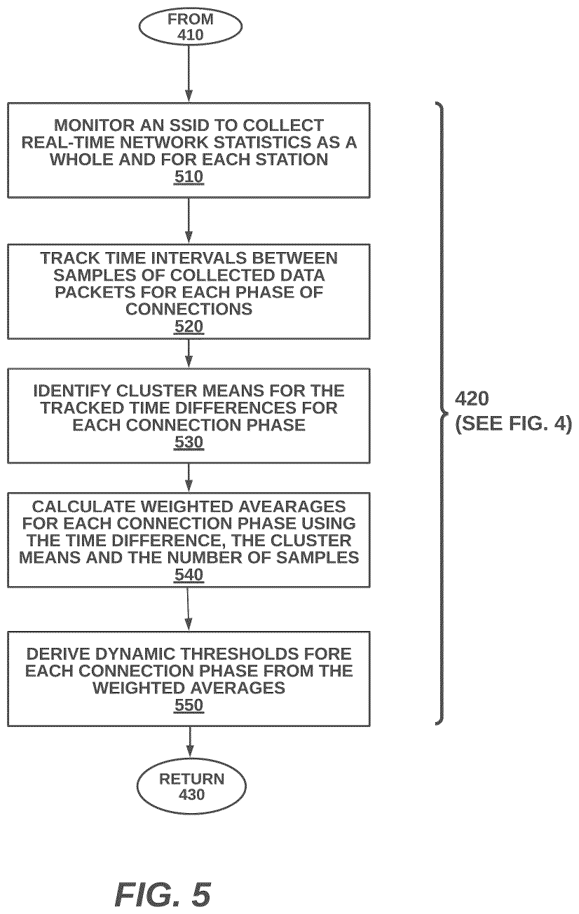

II. Methods for Deriving Connection Thresholds (FIGS. 4-5)

FIG. 4 is a high-level flow diagram illustrating a method 400 for identifying network issues from connectivity data, according to an embodiment. The method 400 can be implemented by, for example, the machine learning connection manager 105 of FIG. 1.

At step 410, an SSID is provided for network devices to connect. There can be several SSIDs in use at the same time.

At step 420, dynamic thresholds are derived for each connection phase, as discussed further below with respect to FIG. 5.

At step 430, a specific dynamic threshold for one of the connection phases is detected to be out of range. At step 440, responsive to the out-of-range detection, network issues corresponding to the phase of the specific dynamic threshold are checked, and identified network issues can be automatically corrected. Some network issues can be exclusively affect a specific phase, thus, aiding identification. Other network issues affect two or all phases.

FIG. 5 is a more detailed flow diagram illustrating the dynamic threshold derivation step 420 of FIG. 4, according to one embodiment.

At step 510, monitoring an SSID, with an exchange of data packets over the enterprise network between network devices, to collect real-time network device connections statistics associated with the SSID as a whole and each station utilizing the SSID.

At step 520, a time interval between samples of collected data packets for each phase of connections is tracked, including the association phase, the authentication phase and the DHCP phase of connecting.

At step 530, cluster means are identified for the tracked time differences for each of the connection phases.

At step 540, weighted averages are calculated for each connection phase using the time difference, the cluster means and the number of samples in each cluster.

At step 550, dynamic thresholds are derived for each connection phase from the weighted averages.

III. Computing Device for Deriving Connection Thresholds (FIG. 6)

FIG. 6 is a block diagram illustrating an exemplary computing device 600 for use in the system 100 of FIG. 1, according to one embodiment. The computing device 600 is an exemplary device that is implementable for each of the components of the system 100, including the machine learning connection manager 105, the Wi-Fi controller 110, the group of access points 120A-C, and the clients 130A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access applications, an access applications that uses networking, a remote access applications executing locally, a network protocol access applications, a network management access applications, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general purpose processor, an access applications-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A method in a network management device to using unsupervised machine learning to derive thresholds for each connection phase, unique for an enterprise network, as a baseline for identifying issues for new connections at different phases, the method comprising:
monitoring an SSID, with an exchange of data packets over the enterprise network between network devices, to collect real-time network device connections statistics associated with the SSID as a whole and each station utilizing the SSID;
tracking a time interval between samples of collected data packets for each phase of connections, including the association phase, the authentication phase and the DHCP phase of connecting;
identifying cluster means for the tracked time differences for each of the connection phases;
calculating weighted averages for each connection phase using the time difference, the cluster means and the number of samples in each cluster;
deriving, with a processor of the network management device, dynamic thresholds for each connection phase from the weighted averages;
detecting a specific dynamic threshold for one of the connection phases that is out of range; and
responsive to the out-of-range detection, checking for network issues corresponding to the phase of the specific dynamic threshold.

2. The method of claim 1, wherein assigned weights for calculating the weighted averages comprises the number of samples for the connection phases divided by the cluster means for the connection phases.

3. The method of claim 1, wherein the weighted averages are proportional to the number of samples.

4. The method of claim 1, wherein the weighted averages are inversely proportional to the cluster means.

5. The method of claim 4, wherein the association phase comprises association request and association request data packets, the authentication phase comprises M1-handshake and M4-handshake data packets, and the DHCP phase comprises DHCP-Discover and DHCP-Acknowledge data packets.

6. The method of claim 1, further comprising:
storing the cluster means and the weighted averages;
tracking time intervals for new samples of collected data; and
recalculating the dynamic thresholds using the stored cluster means and weighted averages with the new time intervals.

7. The method of claim 1, wherein the SSID is configured to an access point.

8. The method of claim 1, wherein the SSID is configured to a plurality of access points, wherein the throughput and the multicast rate baseline are monitored individually for each access point.

9. The method of claim 1, further comprising:
identifying a network issue comprising at least one of: high access point density, Wi-Fi interference, high client density, slow cryptographic algorithm, poor uplink and high channel utilization.

10. A non-transitory computer-readable medium storing instructions that, when executed by a processor, perform a computer-implemented method for using unsupervised machine learning to derive thresholds for each connection phase, unique for an enterprise network, as a baseline for identifying issues for new connections at different phases, the method comprising:
monitoring an SSID, with an exchange of data packets over the enterprise network between network devices, to collect real-time network device connections statistics associated with the SSID as a whole and each station utilizing the SSID;
tracking a time interval between samples of collected data packets for each phase of connections, including the association phase, the authentication phase and the DHCP phase of connecting;
identifying cluster means for the tracked time differences for each of the connection phases;
calculating weighted averages for each connection phase using the time difference, the cluster means and the number of samples in each cluster;
deriving, with a processor of the network management device, dynamic thresholds for each connection phase from the weighted averages;
detecting a specific dynamic threshold for one of the connection phases that is out of range; and
responsive to the out-of-range detection, checking for network issues corresponding to the phase of the specific dynamic threshold.

11. A network device to use unsupervised machine learning to derive thresholds for each connection phase, unique for an enterprise network, as a baseline for identifying issues for new connections at different phases, the network device comprising:
a processor;
a network interface communicatively coupled to the processor and to the hybrid wireless network; and
a memory, communicatively coupled to the processor and storing:
a monitoring module to track an SSID, during exchanges of data packets over the enterprise network between network devices, to collect real-time network device connections statistics associated with the SSID as a whole and each station utilizing the SSID;
a time tracking module to measure a time interval between samples of collected data packets for each phase of connections, including the association phase, the authentication phase and the DHCP phase of connecting;
a cluster means identifying module to find cluster means for the tracked time differences for each of the connection phases;
a weighted averages module to calculate weighted averages for each connection phase using the time difference, the cluster means and the number of samples in each cluster;
a threshold module to derive dynamic thresholds for each connection phase from the weighted averages; and
a threshold module to detect a specific dynamic threshold for one of the connection phases that is out of range, and responsive to the out-of-range detection, and check for network issues corresponding to the phase of the specific dynamic threshold.
